(19) United States
(12) Patent Application Publication
(10) Pub. No.: US 2009/0268711 A1
(43) Pub. Date: Oct. 29, 2009

(54) Synchronization for wireless systems

(75) Inventor: Mika Ventola, Oulu (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: NOKIA CORPORATION

(21) Appl. No.: 12/292,505

(22) Filed: Nov. 20, 2008

(30) Foreign Application Priority Data
Apr. 28, 2008 (EP) 08008117.7

(51) Int. Cl. H04J 3/06

(52) U.S. Cl. 370/350

(57) ABSTRACT

A method, apparatus, and computer program product, wherein a first search bandwidth is set and a preliminary channel scanning is performed at the first search bandwidth to check for existence of a predetermined transmission signal. A second search bandwidth is set and initial channel synchronization is performed at the second search bandwidth, if said preliminary channel scanning indicates existence of the predetermined transmission signal, wherein the second search bandwidth is smaller than the first search bandwidth.

### FIELD

The present application relates to a method, apparatus, and computer program product for a communication system.

### BACKGROUND

High-data-rate communications as defined in the WiMAX IEEE 802.16-2004 standard may pave the way for true broadband, multimedia services over wireless networks. Based on orthogonal-frequency-division-multiplex (OFDM) techniques, the WiMAX physical-layer (PHY) and media-access-control (MAC) protocols are outlined in the IEEE 802.16-2004 standard.

Recently, OFDM has been widely accepted as a promising radio transmission technology for the next generation wireless systems due to its advantages such as the robustness to multi path fading, granular resource allocation capability, and no intracell interference. Among the conventional OFDM-based wireless systems, digital audio broadcasting (DAB), IEEE 802.11a, and Hiperlan/2 are known. For cellular systems, robust synchronization and cell search capability should be provided. However, the synchronization schemes used in such conventional OFDM schemes are not appropriate for a cellular system since they cannot discriminate signals from different cells unless their carrier frequencies are different.

In cellular systems, when a terminal is switched on it has to acquire connection to the network. This is done in a cell search procedure wherein the terminal scans through center frequencies and available bands. The problem of present WiMAX systems is that the terminal does not know the system bandwidth or the center frequency the operator is using, i.e., the terminal has to scan through several system bandwidth options (e.g. 3.5, 5, 7, 10 MHz) together with the center frequency candidates. The center frequencies may occur on a channel raster of, for example 200 or 250 kHz. If the operator is known (i.e. the terminal is designed for a certain operator), it is possible to program the center frequencies and bandwidths the operator is using to the terminal and thus simplify the process. However, there may be several operators and roaming situations, so that the scanning procedure may become exhaustive.

As an example, when scanning starts, a radio frequency (RF) part of the terminal may be tuned to a certain channel by tuning an oscillator to a desired center frequency and by selecting a front end filter, which corresponds to the desired band. If the cell is not transmitting on the desired band or the detection fails for some reason, the scanning process can be repeated. Before the scanning is repeated, the oscillator is tuned to another center frequency in order to search the cell from the higher/lower center frequency and/or another front end filter is selected in order to search for another bandwidth. The scanning process is repeated until the signal is found.

### SUMMARY

In an embodiment, a method comprises setting a first search bandwidth and performing a preliminary channel scanning at the first search bandwidth to check for existence of a predetermined transmission signal; and setting a second search bandwidth and performing initial channel synchronization at the second search bandwidth, if the preliminary channel scanning indicates existence of the predetermined transmission signal, wherein the second search bandwidth is smaller than the first search bandwidth.

Furthermore, an apparatus comprises channel search unit configured to set a first search bandwidth and to perform a preliminary channel scanning at the first search bandwidth to check for existence of a predetermined transmission signal, the channel search unit being further configured to set a second search bandwidth and to perform initial channel synchronization at the second search bandwidth, if the preliminary channel scanning indicates an existence of the predetermined transmission signal, wherein the second search bandwidth is smaller than the first search bandwidth.

Accordingly, the proposed synchronization scheme enables faster cell search by utilizing initial rough or preliminary cell search of the transmission signal on a band that is wider than the bandwidth of the transmission signal. Moreover, as the preliminary scan is done only to see if there is some transmission signal (e.g. WiMAX signal or any other signal of similar characteristic) on the band, accurate frame timing is not required (more accurate search will be done on the actual band). Another benefit is that the preliminary cell search can be done directly from the received time domain transmission signal without converting the received transmission signal to the frequency domain by using an inverse fast Fourier transform operation.

The first search bandwidth may be larger than a system bandwidth of the predetermined transmission signal. This allows the receiver to use the proposed synchronization scheme for different signals with more than one system bandwidth. The bandwidth of the preliminary cell search may be wider than the candidates of the system bandwidths the operator supports. Therefore, it is possible to decide whether it is reasonable to proceed with a multiple number of extensive cell search processes on the preliminary cell search band or not. The benefit of the method is that if the preliminary cell search indicates that the operator is not transmitting on the band of the current preliminary search it is possible to proceed with another preliminary search on another band i.e. the method enables significant time and energy savings.

Furthermore, the sampling frequency, used for receiving the transmission signal, may be selected according to a width of the first search band.

The preliminary channel scanning may comprise a time domain correlation processing and a threshold.

The predetermined transmission signal may comprise a preamble with a conjugate symmetric property in the time domain.

Implementation of the proposed estimation may be based on a computer program comprising code for producing the above method steps when run on a computer device. The computer program may be stored on a computer-readable medium or may be downloadable from a private or public network.

Further advantageous modifications are defined in the dependent claims.

### BRIEF DESCRIPTION OF THE DRAWINGS

In the following, the embodiments in the present application will be described in greater detail with reference to the accompanying drawings, in which:

FIG. 1 shows a schematic block diagram of a communication system in which embodiments in the present application can be implemented;

FIG. 2 shows a schematic block diagram of signal processing components according to an embodiment;

FIG. 3 shows a flow diagram of a synchronization procedure according to the embodiment of FIG. 2;

FIG. 4 shows a frequency diagram indication different selectable search bands;

FIG. 5 shows a schematic block diagram of a terminal device according to another embodiment; and

FIG. 6 shows a schematic block diagram of a software-based implementation according to another embodiment.

### DETAILED DESCRIPTION

Embodiments will now be described based on initial synchronization or re-synchronization in a wireless network environment. Initial synchronization is typically performed upon powering up of a terminal device. After initial synchronization, e.g. in a so-called idle mode, in order to save power, the terminal device may enter a sleep mode or the like by switching off major part(s) of its reception circuitry. In the sleep mode, the terminal device may loose some of its synchronization. Therefore, a re-synchronization process which is the same as the initial synchronization process may be initiated to synchronize to a particular neighboring radio base station.

The proposed synchronization procedure can be applied in any receiver or transceiver arrangement or module provided in a terminal device or a network device. It is applicable to both uplink and downlink transmissions.

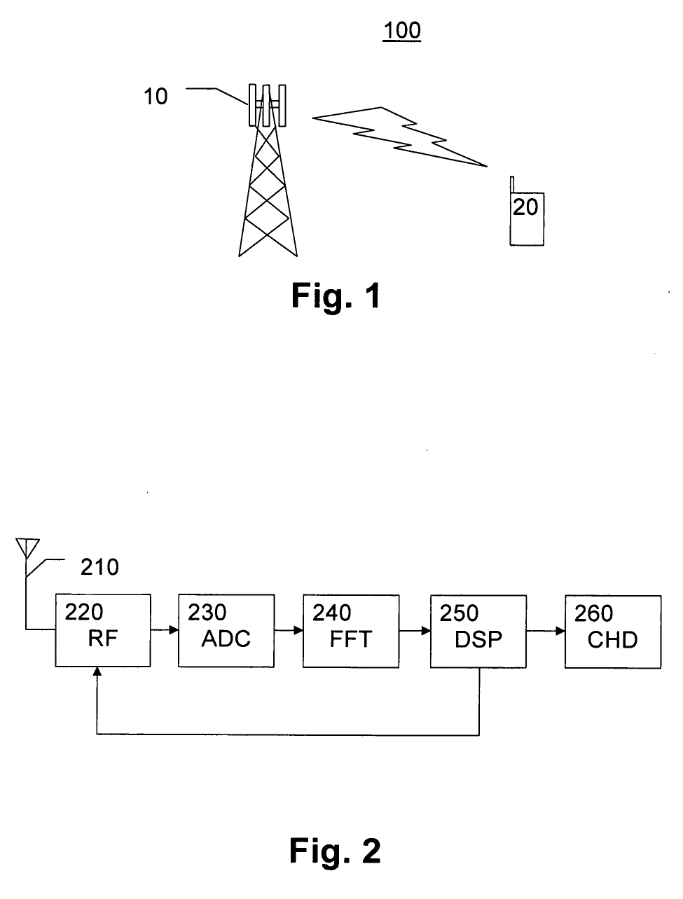

FIG. 1 depicts a communication system 100 that implements wireless communications in accordance with the Institute of Electrical and Electronics Engineers (IEEE) 802.16 broadband wireless access standards (such as WiMax) e.g. for metropolitan area networks (MANs). WiMax specifies the use of orthogonal frequency division multiplexing (OFDM) as a modulation scheme to communicate data between a signal source, such as a base station 10, and a subscriber station, such as a mobile station 20. OFDM enables communication of a large amount of data over a limited bandwidth by allocating the data among multiple smaller sub-signals, and then simultaneously transmitting the sub-signals using different sub-carriers.

FIG. 2 depicts signal processing components of an exemplary receiving chain which may be synchronized in accordance with an embodiment. The signal processing components may be provided in a radio frequency (RF) receiver that receives communication signals. Such components can be, for example, integrated as a chip or chip set into a transceiver of a base station or a subscriber station.

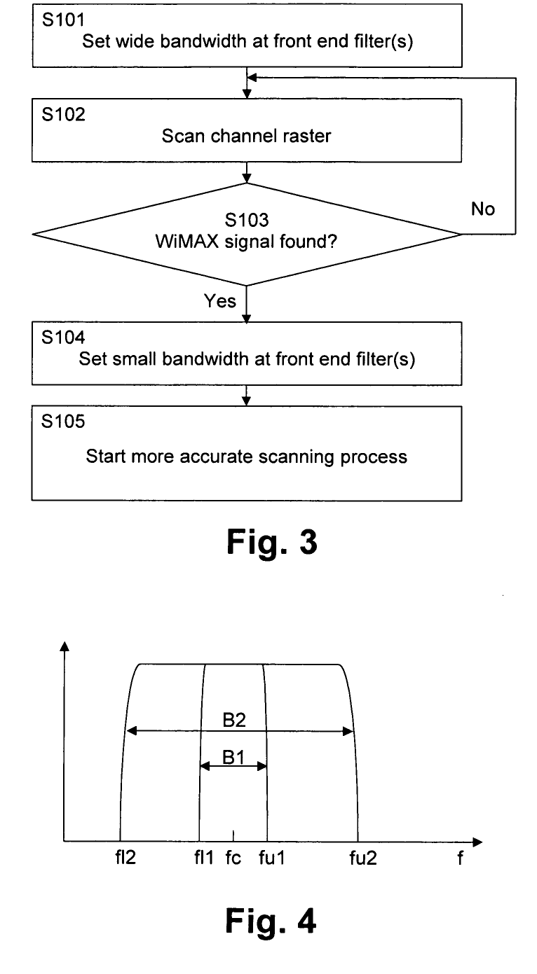

The components or blocks of the exemplary receiving chain shown in FIG. 2 comprise an RF function or stage 220 for detecting and receiving a communication signal 210, an analog-to-digital conversion (ADC) function or stage 230, a fast fourier transformation (FFT) function or module 240, a digital signal processing (DSP) function or stage 250 (e.g. central processing unit (CPU) or the like), and a channel decoding (CHD) function or stage 260. In operation, the RF stage (RF front end) 220 receives the communication signal 210, for instance an OFDM signal that was transmitted in accordance with the IEEE 802.16 broadband wireless access standards (WiMax). The ADC stage 230 can convert the received communication signal into a digital signal and forward the digital signal to the FFT module 240. The FFT module 240 can perform an FFT on the digital signal and output complex signal values to the DSP stage 250, which obtains parameter estimates (e.g. signal and/or noise strength) and controls the CHD stage 260 accordingly. Furthermore, as described below in connection with FIG. 3, the DSP stage 250 is adapted to control the RF stage 220 to set different search bandwidths for initial synchronization or re-synchronization.

FIG. 3 shows a flow diagram of a proposed synchronization procedure according to an embodiment, which could be executed at the DSP stage 250 e.g. based on the suitable software program or routine.

In a first step S101, a wide bandwidth is set at respective front end filter(s) of the RF stage 220. Then, the channel raster is scanned in step S102 by using said wide bandwidth. The DSP stage 250 then or during step S102 checks in step S103 whether e.g. a WiMAX signal has been found. If not, the procedure jumps back to step S102 and channel raster scanning is repeated in step S103. This may be continued until a WiMAX signal has been found in step S103. If so, the procedure proceeds to step S104 where a small(er) bandwidth is set at the front end filter(s) RF stage 220. Then, a more accurate scanning process is started in step S105 to adequately detect the position of the detected WiMAX signal, and then initiate the actual synchronization.

Hence, after the preliminary channel scanning on the wide bandwidth has been done in step S102 and it has been found in step S103 that there actually is some transmission signal inside the wide bandwidth, the position is not known yet (i.e. where inside the wide bandwidth the detected actual transmission occurs). The center frequency of the preliminary search band (wide bandwidth) is not necessarily the same as the center frequency of the actual system band, but can be anywhere inside the wide bandwidth. Therefore, the more accurate scanning process in step S105 is started through the first transmission band until it is found out where the detected transmission occurs and then the procedure can be completed with the actual synchronization.

Moreover, it is noted that there may be a plurality of actual system bands inside the wide bandwidth. In practice, they may not be over-lapping and even if they would be on adjacent bands there might still be some guard band(s) in between. Moreover, there might be an “integer multiple” of empty system bands between the occupied system bands. The preliminary scan in step S102 is thus not limited to determine only one actual system band.

Additionally, multiple preliminary scans may be performed in step S102 before applying the actual synchronization in step S105. As an example, the preliminary scan may be performed on, say, the 40 MHz band. If some transmission is found, the bandwidth of the preliminary search could be halved. Next the preliminary search can be performed again, but now with the halved bandwidth and on “upper” and “lower” 20 MHz halves of the original “preliminary” wide bandwidth of 40 MHz. By doing this, the bandwidth can be narrowed even more before performing the final synchronization procedure, e.g two times on the actual 10 MHz band of the system. Of course, other bandwidth portions may be selected as well, such as for example four portions at 10 MHz or eight portions at 5 MHz.

As an example, the WiMAX preamble has a conjugate symmetric property in the time domain. This conjugate symmetric property can be used when the cell is searched. Moreover, WiMAX is a synchronous system, i.e., the preambles are received (more or less) simultaneously from several base stations. In the frequency domain the preamble occupies the whole bandwidth (e.g. a 5 MHz band) and the band width of the preamble may also be 5 MHz. Due to the network setup the conjugate symmetric property of the preamble holds, even though preamble of a X MHz band is investigated on band larger than X MHz. This allows to utilize prior art cell search procedures on bands that are wider than the actual system band.

FIG. 4 shows a schematic frequency diagram indicating two different exemplary bandwidths B1 and B2 which may be selected and set in the RF stage 220 of FIG. 2. In the example of FIG. 4, both search bands have the same center frequency fc. The larger or wider search band B2 ranges from a lower frequency limit fl2 to an upper frequency limit fu2. The smaller search band ranges from a lower frequency limit fl1 to an upper frequency limit fu1. When the channel raster is scanned, the pass bands B2 of the front end filters at the RF stage 220 are considerably wider than the actual bands B1 that are searched. For example, if the front end filters use a bandwidth of B2=20 MHz, it is still possible to search for all bands inside this 20 MHz wide band regardless of the actual system band. If the signal WiMAX signal has been found inside B2 (e.g. the 20 MHz band), a more accurate scanning process will start by using B1 and conventional initial synchronization unit to perform initial synchronization trials inside the 20 MHz band.

By using the proposed synchronization or cell search procedure it is possible to perform “preliminary” or “rough” scanning so as to check if a WiMAX signal of some band (e.g. B1) is transmitted inside the wide band (e.g. B2) and then perform more accurate search if needed inside the wide band. If no signal seems to be present, the scan can be done on another center frequency but with the same wide band in order to check another part of the spectrum.

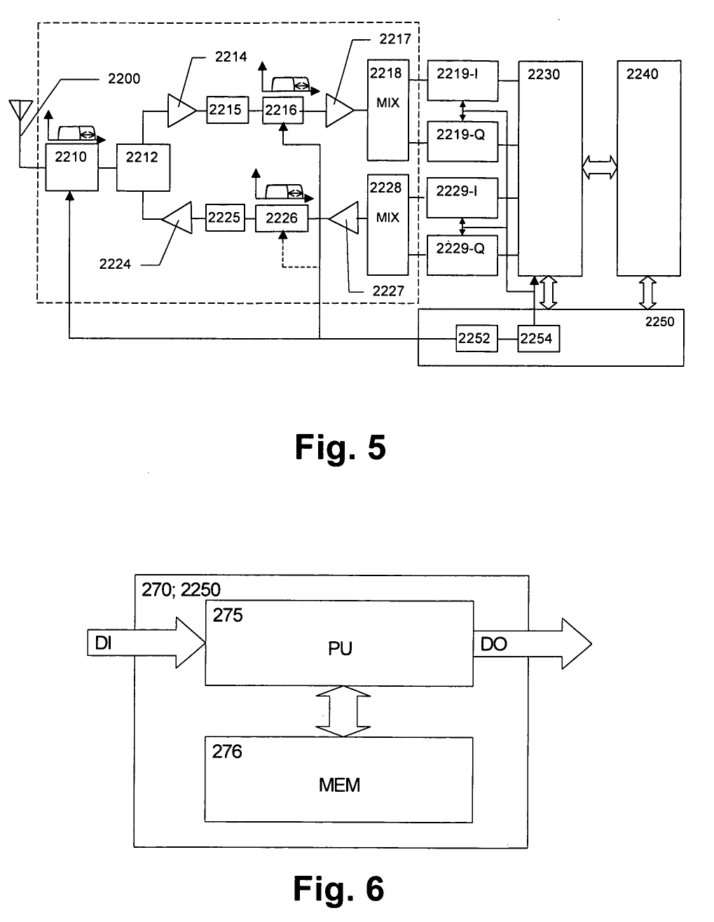

FIG. 5 shows a schematic block diagram of a terminal device (e.g. a WiMAX terminal) according to another embodiment.

The terminal device comprises an RF font end indicated by a dotted box and comprising a first band pass filter 2210 which is connected to an antenna 2200 of the terminal device. At the other side, the first band pass filter 2210 is connected to an antenna switch 2212 for selectively switching the antenna 2200 to an receiving path (upper path or branch in FIG. 5) and a transmitting path (lower path or branch in FIG. 5). The receiving path comprises a low noise amplifier (LNA) 2214 followed by a first mixer circuit 2215 for down-conversion into base band level, a second band path filter 2216, an amplifier 2217 and a second mixer circuit 2218 which generates an in-phase (I) components and a quadrature phase (Q) component of the processed received signal.

In the transmission path, I and Q components of a transmission signal are mixed and combined in a third mixer circuit 2228 to generate a single transmission signal which is amplified in an amplifier 2227 and the filtered at a third band path filter 2226. Then, the filtered transmission signal is up-converted in a fourth mixer circuit 2225 and amplified in a power amplifier 2224 for transmission through the antenna 2200.

The analog I and Q components of the receiving path are supplied to respective ADC circuits 2219-I and 2219-Q where they are sampled and converted into digital components which are supplied to a base band DSP processor 2230. At the transmitting path, the DSP processor 2230 outputs digital I and Q components which are converted into analog components in respective digital-to-analog (DAC) circuits 2229-I and 2229-Q.

Furthermore, the terminal device comprises a control processor 2250 which controls the DSP processor 2230 and a packet processor (e.g. a media access control (MAC) unit) 2240 connected to the DSP processor 2230 and used to enable network access in accordance with the MAC protocol.

The interface for serving a particular band segment is the RF front end. All or at least a part of the components shown in FIG. 5 may be integrated on a single chip or a chip set.

According to the embodiment of FIG. 5, the control processor 2250 comprises a synchronization or cell search managing function or unit 2254 which controls the terminal device to perform the proposed synchronization or cell search procedure e.g. according to FIG. 3. The managing function or unit 2254 controls a bandwidth control function or unit 2252 which generates control signals applied to at least one of the first to third band pass filters 2210, 2216, and 2226 so as to control their respective bandwidths. This bandwidth control may be perform by electronic adjustment of capacitive elements (e.g. varactors, crystal elements, piezo elements or the like) or other controllable semiconductor or non-semiconductor elements which can be used for tuning at least one of bandwidth and center frequency of a band path filter. The control functionality may be provided only for the receiving path or for both receiving and transmitting path. The latter case may be advantageous if the synchronization or cell search procedure comprises a transmitting phase during the preliminary or rough scanning operation.

Additionally, the managing function or unit 2254 may be adapted to control the sampling frequency of the ADC or DAC circuits 2219-I, 2219-Q, 2229-I, and 2229-Q, so as to be adapted to the selected width of the search band, as set by the bandwidth control function or unit 2252. E.g., with a 20 MHz search band the sampling frequency could be two times the sampling frequency of actual the 10 MHz band and/or the FFT length could be 2048 instead of 1024.

In a more specific example, the sampling frequency may be set by the managing function or unit 2254 according to the bandwidth of the preliminary search. Furthermore, the pass band of a front end filter and oscillator are set by the bandwidth control function or unit 2252 according to the band of the preliminary search. Then, the signal is received and sampled. At the DSP processor 2230 conjugate symmetric properties of the preambles are utilized by using autocorrelation to find a correlation peak or maximum that exceeds the threshold. To be more precise, the correlation result may be more like a triangle, so that at least an indication can be made that a transmission signal (e.g. WiMAX signal) is received somewhere inside the preliminary search band.

A more accurate synchronization is then initiated by using a conventional synchronization method or, alternatively, yet another preliminary search may be initiated to further narrow down the scanned band width before proceeding with the more accurate synchronization. The more accurate synchronization will be done by obtaining a signal that corresponds to the bandwidth and center frequency of the actual system band and further using conventional synchronization means on both time and frequency domain. The signal that corresponds to the bandwidth and center frequency of the actual system band can be obtained, for example, from the signal that has been received for the preliminary search by using conventional sample rate conversion means and frequency conversion means. Furthermore, to convert the signal to frequency domain the FFT is set according to the actual system band. As it is not known if such a band exists, all bandwidth candidates the operator may transmit may be tried.

FIG. 6 shows a schematic block diagram of an alternative software-based embodiment of the proposed functionalities for achieving enhanced synchronization or cell search. The required functionalities can be implemented for example in the DSP stage 270 of FIG. 2 or the control processor of FIG. 5 or any similar processing stage of a receiver or transceiver. The embodiment of FIG. 6 comprises a processing unit 275, which may be any processor or computer device with a control unit which performs control based on software routines of a control program stored in a memory 276. Program code instructions are fetched from the memory 276 and are loaded to the control unit of the processing unit 275 in order to perform the processing steps of the above functionalities described in connection with the block diagram of FIG. 3 or the functionality of the managing function or unit 2254 and the bandwidth control function or unit 2252 of FIG. 5. These processing steps may be performed on the basis of input data DI and may generate output data DO, wherein the input data DI may correspond to the receiver input, and the output data DO may correspond to the bandwidth control signals issued by the bandwidth control function or unit 2252 or the sampling and/or FFT control signal issued by the managing function or unit 2254.

Like any other receiver functionality, the above embodiments can be implemented in hardware by a discrete analog or digital circuit, signal processor, or a chip or chip set (e.g. an ASIC (Application Specific Integrated Circuit)), or in software either in an ASIP (Application Specific Integrated Processor), a DSP (Digital Signal Processor), or any other processor or computer device.

In summary, a method, apparatus, and computer program product have been described, wherein a first search bandwidth is set and a preliminary channel scanning is performed at the first search bandwidth to check for existence of a predetermined transmission signal. A second search bandwidth is set and initial channel synchronization is performed at the second search bandwidth, if said preliminary channel scanning indicates existence of the predetermined transmission signal, wherein the second search bandwidth is smaller than the first search bandwidth.

The proposed synchronization or cell search procedure is not limited to WiMAX but can be used in any system that has similar preamble and several system band widths. More specifically, embodiments in the present application can be applied in radio access technologies (e.g. WLAN and WiMAX) and may involve multiple-input multiple-output (MIMO) systems or multi-beam/multi-antenna transmitter or receiver devices (e.g. base station devices, access points or other access devices) capable of receiving signals via different receiving paths and/or channels. The proposed synchronization or cell search procedure may be implemented in a receiver apparatus, a receiver module, a chip set of a receiver, or as a part of a channel estimator subsystem.

As already mentioned, the embodiments can be realized in hardware, software, or a combination of hardware and software. They can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The embodiments also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

Accordingly, the above predetermined embodiments may vary within the scope of the attached claims.

1. A method comprising:
setting a first search bandwidth and performing a preliminary channel scanning at said first search bandwidth to check for existence of a predetermined transmission signal; and
setting a second search bandwidth and performing initial channel synchronization at said second search bandwidth, if said preliminary channel scanning indicates existence of said predetermined transmission signal;
wherein said second search bandwidth is smaller than said first search bandwidth.

2. The method according to claim 1, wherein said first search bandwidth is larger than a system bandwidth of said predetermined transmission signal.

3. The method according to claim 1, further comprising selecting a sampling frequency, used for receiving said transmission signal, according to a width of the first search band.

4. The method according to claim 1, wherein said preliminary channel scanning comprises a correlation processing and a threshold.

5. The method according to claim 1, wherein said predetermined transmission signal comprises a preamble with a conjugate symmetric property in the time domain.

6. An apparatus comprising:
a channel search unit configured to set a first search bandwidth and to perform a preliminary channel scanning at said first search bandwidth to check for existence of a predetermined transmission signal, said channel search unit being further configured to set a second search bandwidth and to perform initial channel synchronization at said second search bandwidth, when said preliminary channel scanning indicates existence of said predetermined transmission signal, wherein said second search bandwidth is smaller than said first search bandwidth.

7. The apparatus according to claim 6, wherein said channel search unit is configured to set said first search bandwidth to a value larger than a system bandwidth of said predetermined transmission signal.

8. The apparatus according to claim 6, further comprising a selector configured to select a sampling frequency, used for receiving said transmission signal, in accordance with a width of the first search band.

9. The apparatus according to claim 6, wherein said channel search unit is further configured to use a correlation processing and a threshold in preliminary channel scanning.

10. The apparatus according to claim 6, wherein said predetermined transmission signal comprises a preamble with a conjugate symmetric property in the time domain.

11. The apparatus according to claim 6, wherein said apparatus comprises a terminal device, a receiver module, or a chip device.

12. A computer program embodied on a computer-readable medium configured to control a processor to perform:
setting a first search bandwidth and performing a preliminary channel scanning at said first search bandwidth to check for existence of a predetermined transmission signal; and
setting a second search bandwidth and performing initial channel synchronization at said second search bandwidth, if said preliminary channel scanning indicates existence of said predetermined transmission signal,
wherein said second search bandwidth is smaller than said first search bandwidth.

13. A computer program according to claim 12, wherein said first search bandwidth is larger than a system bandwidth of said predetermined transmission signal.

14. A computer program according to claim 12, further comprising selecting a sampling frequency, used for receiving said transmission signal, according to a width of the first search band.

15. A computer program according to claim 12, wherein said preliminary channel scanning comprises a correlation processing and a threshold.

16. The computer program according to claim 12, wherein said predetermined transmission signal comprises a preamble with a conjugate symmetric property in the time domain.

17. An apparatus comprising:
first setting means for setting a first search bandwidth and for performing a preliminary channel scanning at said first search bandwidth to check for existence of a predetermined transmission signal; and
second setting means for setting a second search bandwidth and for performing initial channel synchronization at said second search bandwidth, when said preliminary channel scanning indicates existence of said predetermined transmission signal, wherein said second search bandwidth is smaller than said first search bandwidth.

18. The apparatus according to claim 13, further comprising selecting means for selecting a sampling frequency, used for receiving said transmission signal, in accordance with a width of the first search band.

19. The apparatus according to claim 13, wherein said apparatus comprises a terminal device, a receiver module, or a chip device.
